(19) United States
(12) Patent Application Publication
(10) Pub. No.: US 2003/0012217 A1
(43) Pub. Date: Jan. 16, 2003

(54) CHANNEL-TYPE SWITCHING TO A COMMON CHANNEL BASED ON COMMON CHANNEL LOAD

(76) Inventors: CHRISTOFFER ANDERSSON, PALO ALTO, CA (US); JOHAN SODERBERG, LULEA (SE)

Correspondence Address: NIXON & VANDERHYE P C, 1100 NORTH GLEBE ROAD, 8TH FLOOR, ARLINGTON, VA, 22201-4714, US

(21) Appl. No.: 09/429,497

(22) Filed: Oct. 29, 1999

(51) Int. Cl. H04J 3/16; H04Q 7/00

(52) U.S. Cl. 370/437

(57) ABSTRACT

A channel-type switching control approach permits a variety of communication services to be provided in an efficient manner. A parameter affecting the decision whether to switch a user connection from a first type of communications channel to a second type of communications channel is detected. A channel-type switching decision is then made so as to reduce undesirable channel-type switching. Undesirable channel-type switching may include inefficient, excessive, or rapid cyclic switching of the user connection between the first and second channel-types. An undesirable channel-type switch may also be one where the “cost” of making the channel-type switch to the second type of channel is “more expensive” than the cost of maintaining the user connection on the first type of channel. In an example embodiment, the channel switching decision takes into account a current throughput over the second type of channel. The first type of channel may be, for example, a dedicated radio channel dedicated to a mobile radio user connection, and the second type of channel may be a common radio channel shared by plural mobile radio user connections. The throughput on the common channel may be determined based upon a number of mobile radio user connections currently being supported on the common radio channel and a data rate or capacity of the common radio channel. The channel-type switching decision may also take into account other factors and parameters.

### RELATED INVENTION

This application is related to commonly assigned patent application Ser. No. 09/______, filed Oct. 29, 1999 (attorney docket: 2380-148), entitled “Channel-Type Switching from a Common Channel to a Dedicated Channel Based on Common Channel Load.”

### FIELD OF THE INVENTION

The present invention relates to data packet communications, and in particular, to controlling switching between communication channels of different types.

### BACKGROUND AND SUMMARY OF THE INVENTION

In current and future mobile radio communications systems, a variety of different services either are or will be provided. While mobile radio systems have traditionally provided circuit-switched services, e.g., to support voice calls, packet-switched data services are also becoming increasingly important. Example packet data services include e-mail, file transfers, and information retrieval using the Internet. Because packet data services often utilize system resources in a manner that varies over the course of a data packet session, the flow of packets is often characterized as “bursty.” Transmitted packet bursts are interspersed with periods where no packets are transmitted so that the “density” of packets is high for short time periods and often very low for long periods.

Mobile communications systems must be able to accommodate both circuit-switched services and packet-switched services. But at the same time, the limited radio bandwidth must be used efficiently. Consequently, different types of radio channels may be employed to more efficiently accommodate different types of traffic to be transported across the radio interface.

The Global System for Mobile communications (GSM is one example of a mobile communications system that offers circuit-switched services via a Mobile Switching Center (MSC) node and packet-switched services via a General Packet Radio Service (GPRS) node. For circuit-switched, guaranteed service, dedicated traffic channels are employed. A radio channel is dedicated (for the life of the mobile connection) to a particular mobile user and delivers frames of information as received without substantial delay. Typically, a dedicated channel provides a high data throughput. For packet-switched, best effort service, common channels are employed where plural mobile users share the common channel at the same time. Typically, a common channel delivers packets of information at a relatively low data throughput. Thus, when the quality of service parameter(s) requested is (are) relatively high, e.g., for a speech or synchronized communication, soft/softer handover, etc., a dedicated, circuit-switched channel is well suited to handle this kind of traffic. When the quality of service requested is relatively low, e.g., for an e-mail message, or if the user only has a small amount of data to transmit, a common, packet-switched channel is well suited to handle this kind of traffic. However, there is no “switching” between different types of channels in GSM/GPRS. All dedicated traffic is GSM circuit-switched, and all common traffic is GPRS packet-switched.

The selection of the appropriate channel type and channel type switching are prominent features to be included in third generation mobile systems that employ Wideband Code Division Multiple Access (W-CDMA). The third generation wideband CDMA systems must support a variety of circuit-switched and packet-switched services over a wide range of bit rates, e.g., kilobits per second to megabits per second. Two of the most critical radio resources in wideband CDMA needed to support such services are channelization codes and transmission power. Channelization codes are used to reduce interference and to separate information between different users. The more channel capacity required, the more channelization codes that must be allocated. The other critical radio resource is transmission power/interference level. Dedicated channels employ closed loop transmit power control which provides more accurate power assignments resulting in less interference and lower bit error rate. Common channels usually employ open loop power control which is less accurate and not as well suited for transmitting large amounts of data.

There are additional challenges in wideband CDMA systems to offering new and diverse services while at the same time effectively and efficiently distributing the limited system resources. For example, while data traffic is by nature “bursty,” as described above, traffic patterns are also affected by the particular transmission protocol employed. For example, the most commonly used transmission protocol on the Internet today is Transmission Control Protocol (TCP). TCP provides reliable, in-order delivery of a stream of bytes and employs a flow control mechanism and a congestion control mechanism. The amount of data delivered for transmission is regulated based on the amount of detected congestion, i.e., packets lost due to overflow in routers caused by traffic greater than the network capacity. To accomplish this regulation, when TCP senses the loss of packets, it reduces the transmission rate by half or more and only slowly increases that rate to gradually raise throughput. Another factor to consider is the use of different Quality of Service (QoS) classes. For example, three different priority classes may be provided to users in a network: low priority would include users with small demands in throughput and delays (e.g., an e-mail user), medium priority users that demand a higher level of throughput (e.g., Web service), and high priority users requiring high throughput with low delays (e.g., voice, video, etc.).

Because of the bursty nature of packet data transmissions, congestion-sensitive transmission protocols, QoS parameters, and other factors, (collectively “dynamic aspects” of packet data transmissions), the channel-type best-suited to efficiently support a user connection often changes during the life of that user connection. At one point, it might be better for the user connection to be supported by a dedicated channel, while at another point it might be better for the user connection to be supported by a common channel. The problem addressed by the present invention is determining if, when, and how often to make a channel-type switch during the course of a particular user connection.

One way of determining when to switch a user connection from a dedicated channel to a common channel is to monitor the amount of data currently being stored in a transmission buffer associated with that user connection. When the amount of data stored in the buffer is less than a certain threshold, that smaller amount of data may not justify the use of a dedicated channel. On the other hand, the decrease in the amount of data to be transmitted for that user may only be temporary, given the dynamic aspects of data transmission, and the amount of data in the buffer may quickly accumulate because of the load on the common channel or increased capacity needs for the connection. As a result, the connection may need to be switched right back to a dedicated channel.

Consider the situation where a user connection is currently assigned a dedicated radio channel having a higher data transmission rate/capacity than the current incoming rate of the user data to be transmitted over that channel. This situation might arise if there is congestion at some part of the Internet, e.g., Internet congestion causes TCP to dramatically reduce its transmission rate as described above. A slower incoming rate may also be the result of a “weak link” in the connection external to the radio network, e.g., a low speed modem. In such situations, the radio transmit buffer is emptied faster than the data to be transmitted arrives. As a result of the slow incoming data rate, which may very well only be temporary, the user connection is switched to a common channel, even though soon thereafter, the user has a large amount of data to transmit. Consequently, shortly after the user connection is transmitted to the common channel, the buffer fills up rapidly due to lower throughput on the common channel, and the user connection is switched right back to a dedicated channel. These conditions may ultimately result in rapid, prolonged switching back and forth between a common channel and a dedicated channel as long as such conditions persist. Such “ping-pong” effects are undesirable because each channel type switch consumes power of the battery-operated terminal, loses packets during the switch, and requires additional control signaling overhead.

FIG. 1 is a graph simulating a constant 32 kbit/sec incoming data stream to the transmission buffer where the user connection is assigned a dedicated channel with a capacity of 64 kbit/sec. The common channel capacity was simulated at 16 kbit/sec but is illustrated as 0 kbit/sec in FIG. 1. The buffer's channel switch threshold which triggers a switch from dedicated-to-common channel and from common-to-dedicated channel is set at 1000 bytes. An expiration timer is set to one second. FIG. 1 shows the allocated achieved channel capacity (in kbit/sec) plotted against time under these simulated conditions where the user connection is cyclically switched between a 64 kbps dedicated channel (after about one second) and a common channel (after less than 0.5 seconds).

FIG. 2 shows the buffer amount (in bytes) versus time for this same simulation. The buffer amount is approximately 600 bytes when the user is on the dedicated channel, which is below the threshold of 1,000 bytes. Therefore, the user connection is switched to the common channel as soon as the one second timer expires. But on the common channel, the transmit buffer is filled very quickly by the 32 kbit/sec incoming stream up to about 2000 bytes which, because it exceeds the 1000 byte threshold, results in a rapid channel switch back to the dedicated channel. This kind of rapid channel switch cycling “ping-pong” effect) is undesirable, as described earlier, because of the resources necessary to orchestrate each channel-type switch and the time required to set up a dedicated channel.

The present invention solves the above-identified problems. A parameter affecting a decision whether to switch the user connection from a first type of channel to a second type of channel is detected. A channel-type switching decision is then made so as to reduce undesirable channel-type switching. Undesirable channel-type switching may include inefficient, excessive, or rapid cyclic switching of the user connection between the first and second channel-types. An undesirable channel-type switch may also be one switch where the “cost” of making the channel-type switch to the second type of channel is “more expensive” than the cost of maintaining the user connection on the first type of channel.

In one preferred example embodiment, the channel switching decision takes into account both and a current throughput over the second type of channel and some other parameter like an expiration time out period, an amount of data to be transmitted over the user connection, or whether channel-type switching conditions for switching right back from the second type of channel to the first type of channel are also met. Other parameters and/or conditions may also be used. The first type of channel may be a dedicated radio channel dedicated to a mobile radio user connection, and the second type of channel may be a common radio channel shared by plural mobile radio user connections. The first type of channel could also be another common channel. The throughput on the common channel may be determined based upon a number of mobile radio user connections currently being supported on the common radio channel and a data rate or capacity of the common radio channel. Other user connection-specific factors like priority may also be considered to estimate what throughput would likely be obtained for the user connection if it were switched to the common radio channel.

A decision to switch the user connection to the common channel is considered when the throughput on the dedicated channel is less than the detected throughput over the common channel for this particular user connection. Preferably, although not necessarily, the condition(s) for switching user connections in the opposite direction from the common channel to the dedicated channel are also considered, e.g., whether the user connection buffer amount exceeds a particular threshold. The user connection is maintained on the dedicated channel when the detected throughput is not greater than the throughput threshold, i.e., if the incoming data rate for the user connection on the dedicated channel is greater than the outgoing capacity on the common channel. In addition, a channel switch is not made if the condition(s) for switching right back to the dedicated channel are also satisfied.

By taking into account the throughput on a second type of channel, e.g., a common-type channel, the present invention prevents making a channel-type switch if the throughput on the common channel is so low that it will not be able to satisfactorily handle the amount of data to be transmitted for the user connection. To avoid rapid, back and forth channel-type switching, the condition(s) for switching in the opposite direction are also considered. On the other hand, if the throughput on the common channel is sufficiently high and the conditions for switching right back are not present, it is likely worthwhile to make the channel-type switch since the full capacity of the dedicated channel is not being utilized resulting in inefficient use of the radio bandwidth. The channel switching decision may also be based on one or more additional parameters including for example a priority associated with the user connection or other quality of service associated with the user connection, etc.

An expiration timer may be used, for example, to make sure throughput conditions have existed for a sufficient time to warrant a channel switch. A timer length is preferably determined based at least in part on the current system load. For increasing loads, the timer length is decreased. Conversely, for decreasing loads, the timer length is increased. The timer may be started when the throughput on the dedicated channel goes below a throughput threshold. The timer may be stopped if that throughput increases above the same or a different (e.g., higher) throughput threshold. The user connection is switched only if the timer times out (and any other imposed conditions are satisfied).

In a preferred example embodiment, the present invention may be implemented in a radio network control node having plural buffers, each buffer being assignable to support a mobile user connection and having a corresponding threshold. Channel-type switching circuitry, coupled to the buffers, controllably switches a user connection from a first type of radio channel to a second type of radio channel. A measurement controller obtains measurements of a current amount of data stored in each buffer and of a current throughput on the second type of channel. A channel-type switching controller controls the channel-type switching circuitry to direct data corresponding to one of the mobile user connections stored at one of the buffers from a first type of radio channel currently supporting the mobile user connection to a second type of radio channel based on the measurements from the measurement controller.

### BRIEF DESCRIPTION OF THE DRAWINGS

The foregoing and other objects, features, and advantages of the invention will be apparent from the following description of preferred example embodiments as well as illustrated in the accompanying drawings in which reference characters refer to the same parts throughout. While individual functional blocks and components are shown in many of the figures, those skilled in the art will appreciate these functions may be performed by individual hardware circuits, by a suitably programmed digital microprocessor or general purpose computer, by an application specific integrated circuit (ASIC), and/or by one or more digital signaling processes (DSPs).

FIG. 1 is a graph illustrating allocated channel capacity versus time in a simulated channel switching scenario;

FIG. 2 is a graph illustrating transmission buffer content versus time in the simulated scenario of FIG. 1;

FIG. 3 is a flowchart diagram illustrating a channel-type switching method in accordance with one example embodiment of the present invention;

FIG. 4 is a function block diagram illustrating a Universal Mobile Telephone System (UMTS) in which the present invention may be advantageously employed;

FIG. 5 is a function block diagram of a radio network controller and a base station shown in FIG. 4;

FIG. 6 is a function block diagram of a mobile station;

FIG. 7 is a diagram illustrating transmission protocol layers that may be employed in the UMTS system shown in FIG. 4;

FIGS. 8-9 are flowchart diagrams illustrating example radio channel-type switching procedures that may be used in the UMTS system shown in FIG. 4;

FIG. 10 is a function block diagram illustrating an example implementation of the present invention in a radio network controller; and

FIG. 11 is a function block diagram illustrating channel switching from the prospective of a mobile station in accordance with one example embodiment.

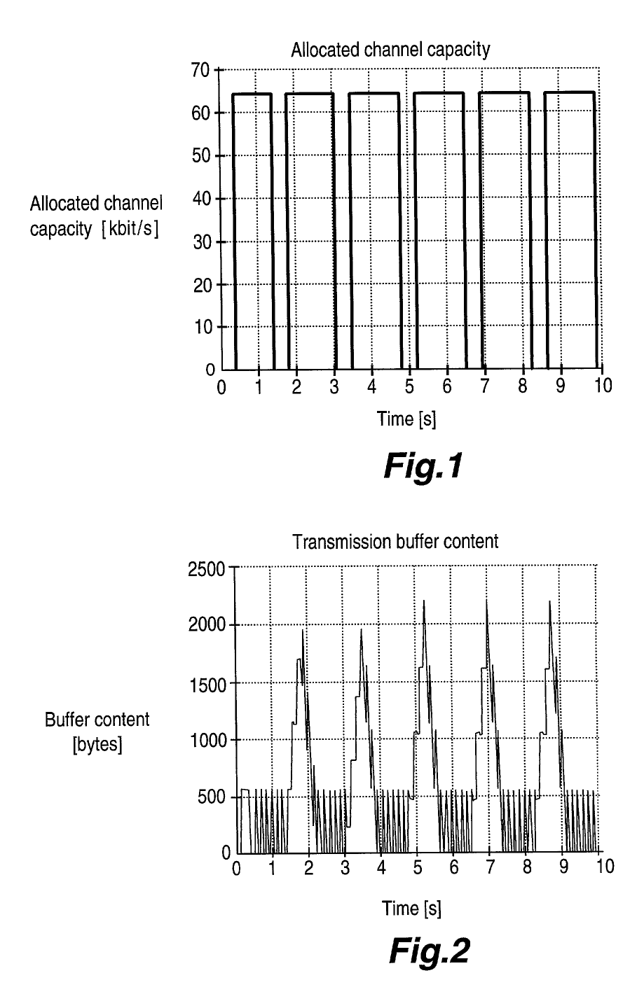

### DETAILED DESCRIPTION OF THE DRAWINGS

In the following description, for purposes of explanation and not limitation, specific details are set forth, such as particular embodiments, network architectures, signaling flows, protocols, techniques, etc., in order to provide an understanding of the present invention. However, it will be apparent to one skilled in the art that the present invention may be practiced in other embodiments that depart from these specific details. For example, while the present invention is disclosed in the example context of channel-type switching from a dedicated type of channel to a common or shared type of channel, those skilled in the art will appreciate the present invention can be applied to other types of channel switching situations including for example switching from another type of channel, such as a second common channel, the first common channel, etc. However, to simply the description, reference is made to switching from a dedicated channel to a common channel. Moreover, although the present invention is disclosed in the example context of mobile radio communications, it may also be employed in any type of communications system where channel-type switching may be employed. In other instances, detailed descriptions of well-known methods, interfaces, devices, protocols, and signaling techniques are omitted so as not to obscure the description of the present invention with unnecessary detail.

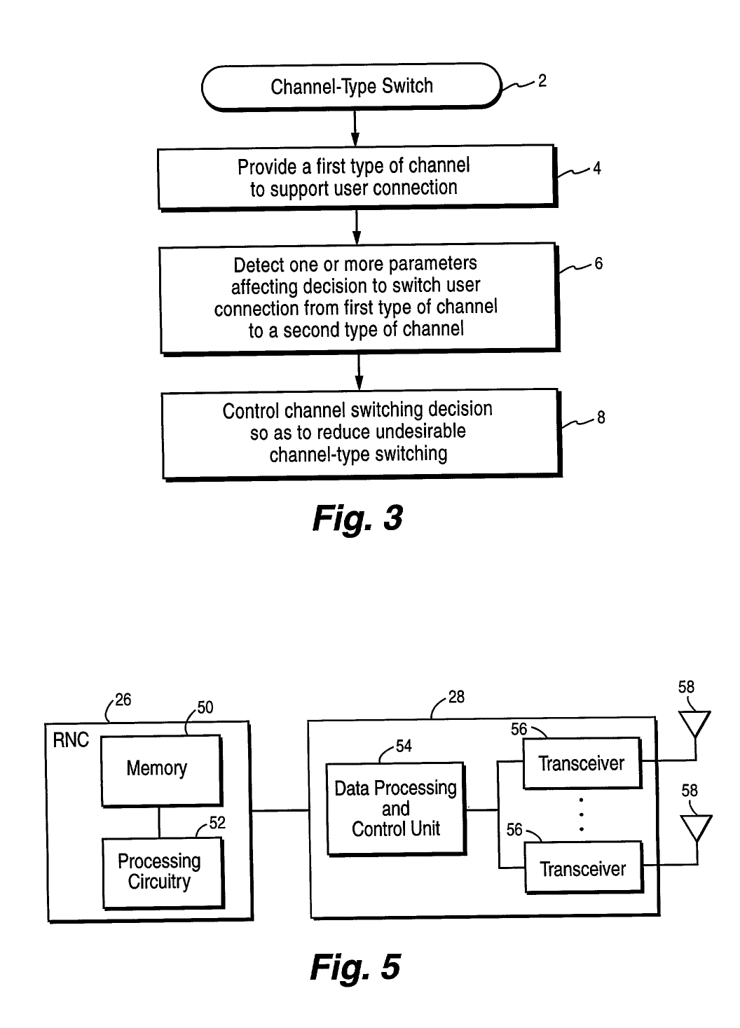

A general description of the present invention is now provided with reference to the channel-type switching method (block 2) illustrated in function block format in FIG. 3. This method may be implemented in any type of communications system (including both wired and wireless) where a user connection may be switched to different types of channels.

A communications channel allocation entity provides a first type of communications channel to support a user connection (block 4). One or more parameters that affect the decision to switch the user connection from a first type of channel to a second type of channel are detected (block 6). When evaluating the one or more parameters so detected, the channel switching decision is controlled so that undesirable channel-type switching is reduced (block 8). This control operation prevents or reduces inefficient, excessive, or rapid cyclic switching of the user connection between the first and second channel-types. A channel-type switch also may be avoided when the “cost” of making the channel-type switch to the second type of channel is “more expensive” than the cost of maintaining the user connection on the first type of channel. The cost may include for example data processing resources associated with channel setup and take down, the delay associated with channel setup and take down, the use (efficient or inefficient) of limited channel resources, battery drain in the mobile associated with channel switching, etc. Furthermore, different user priorities can be flexibly and efficiently supported. For example, a lower volume, high priority user may remain on a dedicated channel even though, from an efficiency perspective, it might be a more efficient use of resources to switch to a common channel. As a result, increased performance can be provided to high priority users without adversely impacting the efficient use of limited resources for lower priority users.

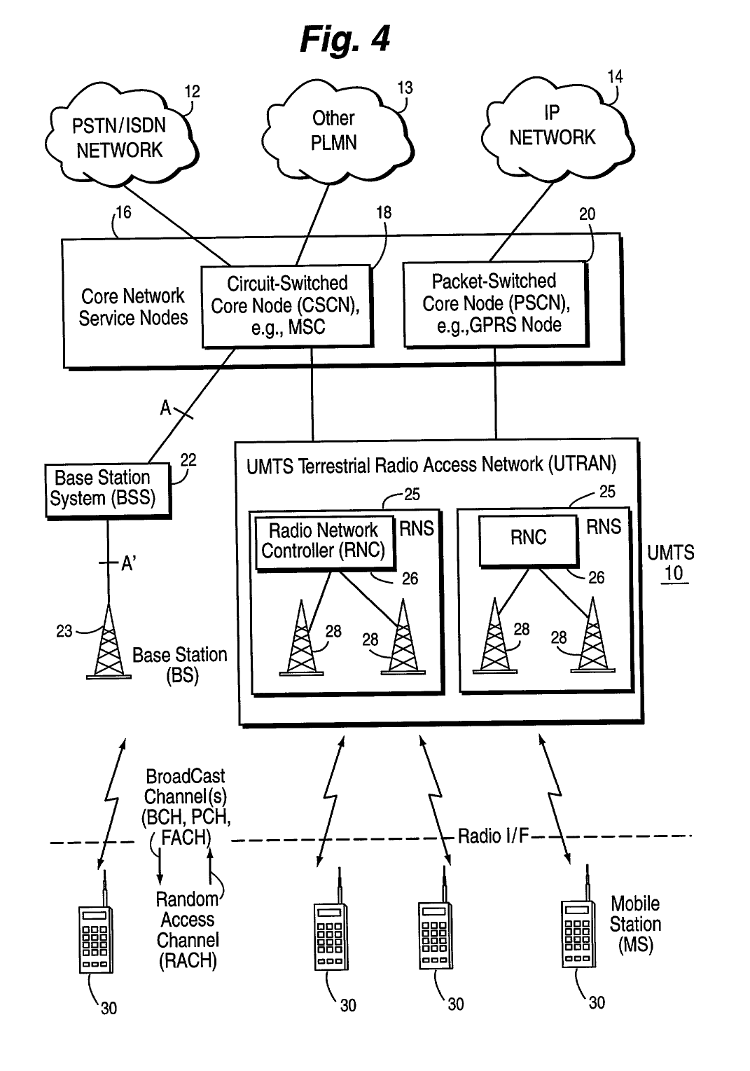

One advantageous application of the present invention is now described in the non-limiting, example context of a universal mobile telecommunications system (UMTS) 10 shown in FIG. 4. A representative, circuit-switched, external core network, shown as a cloud 12 may be for example the public switched telephone network (PSTN) and/or the integrated services digital network (ISDN). Another circuit-switched, external core network may correspond to another Public Land Mobile radio Network (PLMN) 13. A representative, packet-switched, external core network shown as cloud 14 may be for example an IP network such as the Internet. The core networks are coupled to corresponding network service nodes 16. The PSTN/ISDN network 12 and other PLMN network 13 are connected to a circuit-switched core node (CSCN), such as a Mobile Switching Center (MSC), that provides circuit-switched services. The UMTS 10 may co-exist with an existing cellular network, here the Global System for Mobile Communications (GSM), where the MSC 18 is connected over an interface A to a base station subsystem (BSS) 22 which in turn is connected to a radio base station 23 over an interface A′. The packet-switched network 14 is connected over interface Gb to a packet-switched core node (PSCN), e.g., a General Packet Radio Service (GPRS) node 20 tailored to provide packet-switched type services in the context of GSM which is sometimes referred to as the Serving GPRS Service Node (SGSN). Each of the core network service nodes 18 and 20 also connects to a UMTS terrestrial radio access network (UTRAN) 24 over a radio access network interface. The UTRAN 24 includes one or more radio network systems (RNS) 25 each with a radio network controller (RNC) 26 coupled to a plurality of base stations (BS) 28 and to the RNCs in the UTRAN 24.

Preferably, radio access over the radio interface in the UMTS 10 is based upon wideband, Code Division Multiple Access (WCDMA) with individual radio channels allocated using CDMA channelization or spreading codes. Of course, other access methods may be employed like the well known TDMA access used in GSM. WCDMA provides wide bandwidth for multimedia services and other high transmission rate demands as well as robust features like diversity handoff and RAKE receivers to ensure high quality communication service in a frequently changing environment. Each mobile station is assigned its own scrambling code in order for a base station 28 to identify transmissions from that particular mobile station. The mobile station also uses its own scrambling code to identify transmissions from the base station either on a general broadcast or common channel or transmissions specifically intended for that mobile station. That scrambling code distinguishes the scrambled signal from all of the other transmissions and noise present in the same area.

Different types of control channels are shown bridging the radio interface. For example, in the forward or downlink direction, there are several types of broadcast channels including a general broadcast channel (BCH), a paging channel (PCH), and a forward access channel (FACH) for providing various types of control messages to mobile stations. In the reverse or uplink direction, a random access channel (RACH) is employed by mobile stations whenever access is desired to perform location registration, call origination, page response, and other types of access operations.

Simplified function block diagrams of the radio network controller 26 and base station 28 are shown in FIG. 5. The radio network controller 26 includes a memory 50 coupled to data processing circuitry 52 that performs numerous radio and data processing operations required to perform its control function and conduct communications between the RNC and other entities such as the core network service nodes, other RNCs, and base stations. Data processing circuitry 52 may include any one or a combination of suitably programmed or configured general purpose computer, microprocessor, microcontroller, dedicated logic circuitry, DSP, ASIC, etc., as described above. The base station 28 includes a data processing and control unit 54 which, in addition to performing processing operations relating to communications with the RNC 26, performs a number of measurement and control operations associated with base station radio equipment including transceivers 56 connected to one or more antennas 58.

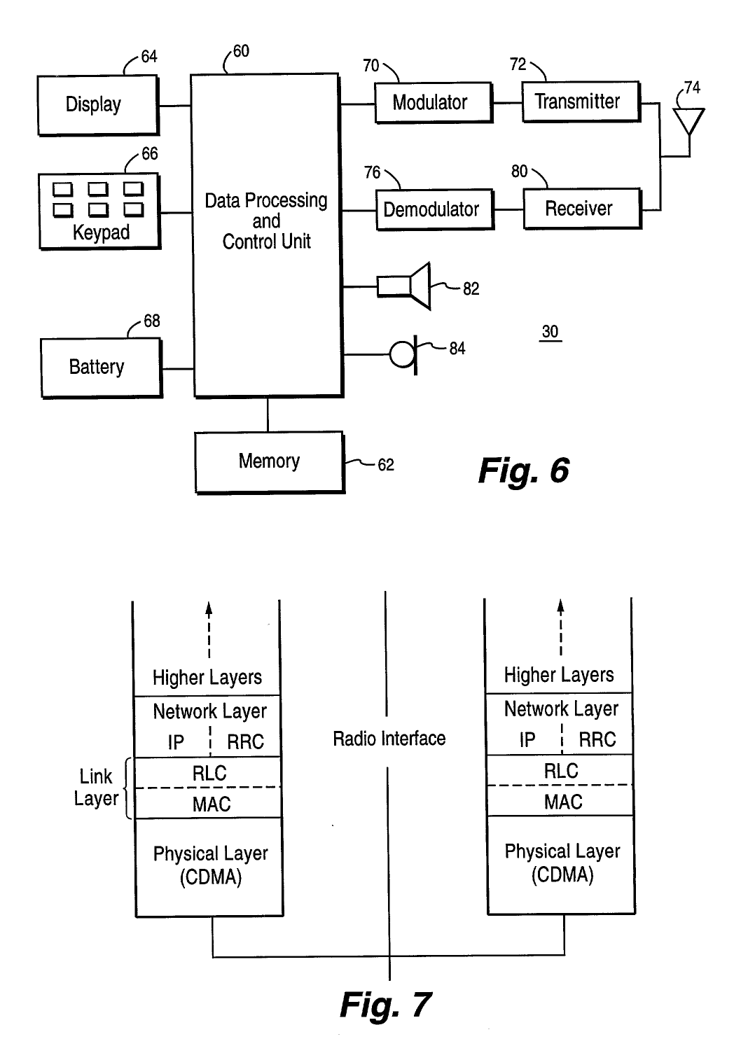

A simplified function block diagram of a mobile station 30 is shown in FIG. 6. The mobile station 30 includes an antenna 74 for transmitting signals to and for receiving signals from a base station 28. The antenna 74 is coupled to radio transceiving circuitry including a modulator 70 coupled to a transmitter 72 and a demodulator 76 coupled to a receiver 80. The radio transceived signals include signaling information in accordance with an air interface standard applicable to the wideband CDMA system shown in FIG. 3. The data processing and control unit 60 and memory 62 include the circuitry required for implementing audio, logic, and control functions of the mobile station. Memory 62 stores both programs and data. Conventional speaker or earphone 82, microphone 84, keypad 66, and display 64 are coupled to the data processing and control unit 60 to make up the user interface. A battery 68 powers the various circuits required to operate the mobile station.

The radio interface shown in FIG. 4 is divided into several protocol layers with several lower level layers illustrated in FIG. 7. In particular, a mobile station uses these protocol layers to communicate with similar protocol layers in the UTRAN. Both protocol stacks include: a physical layer, a data link layer, a network layer, and higher layers. The data link layer is split into two sublayers: a radio link control (RLC) layer and medium access control (MAC) layer. The network layer is divided in this example into a control plane protocol (RRC) and a user plane protocol (IP).

The physical layer provides information transfer services over the air interface using wideband CDMA performs the following functions: forward error correction encoding and decoding, macrodiversity distribution/combining, soft handover execution, error detection, multiplexing and demultiplexing of transport channels, mapping of transport channels onto physical channels, modulation and spreading/demodulation and despreading of physical channels, frequency and time synchronization, power control, RF processing, and other functions.

The medium access control (MAC) layer provides unacknowledged transfer of service data units (SDUs) between peer MAC entities. The MAC functions include selecting an appropriate transport format for each transport channel depending on data rate, priority handling between data flows of one user and between data flows of different users, scheduling of control messages, multiplexing and demultiplexing of higher layer PDUs, and other functions. In particular, the MAC layer performs dynamic radio transport channel-switching functions. The RLC performs various functions including the establishment, release, and maintenance of an RLC connection, segmentation and reassembly of variable length, higher layer PDUs into/from smaller RLC PDUs, concatenation, error correction by retransmission (ARQ), in sequence delivery of higher layer PDUs, duplicate detection, flow control, and other functions. The transmit buffers assigned to mobile user connections are controlled at the RLC layer.

The control plane part of the network layer in the UTRAN consists of a radio resource control protocol (RRC). The RRC protocol allocates radio resources and handles the control signaling over the radio interface, e.g., radio access bearer control signaling, measurement reporting and handover signaling. The user plane part of the network layer includes the traditional functions performed by layer 3 protocols such as the well known Internet Protocol (IP).

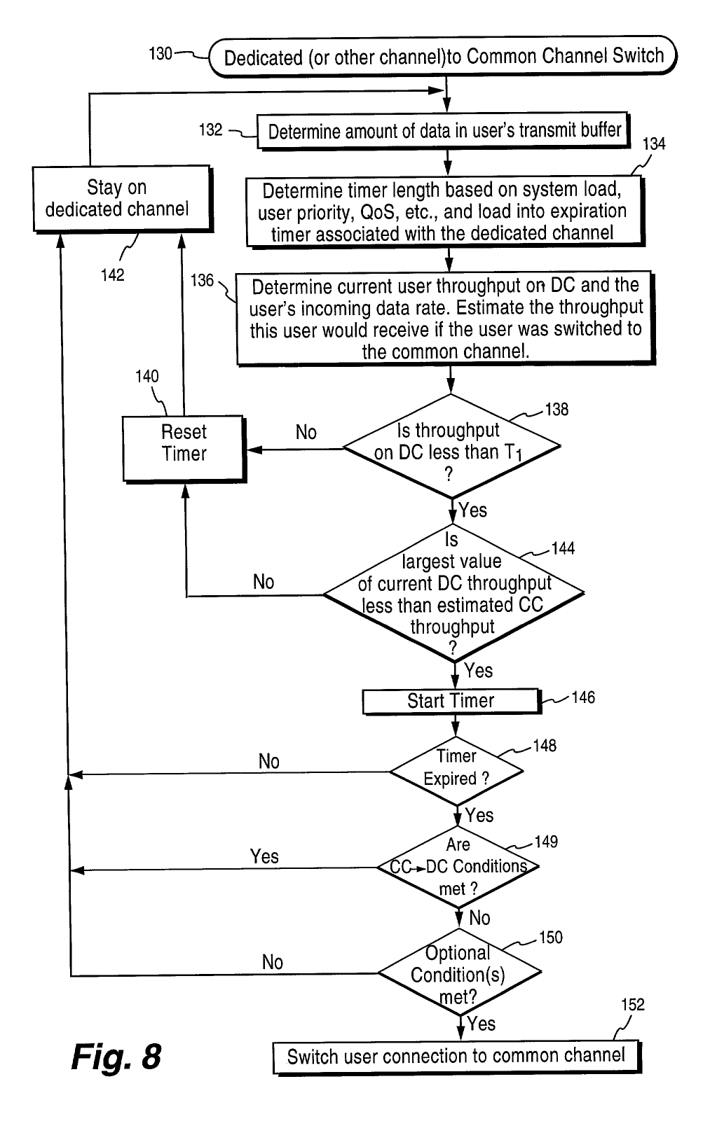

FIG. 8 shows one non-limiting, example application of the invention in the context of a dedicated-to-common channel-type switching routine 130 where the mobile user connection is currently being supported by a dedicated type of radio channel and is considered for switching down to a common type of radio channel. As indicated above, this routine may be applied to channel-type switches from any higher capacity or QoS channel to a lower capacity or QoS channel; however, dedicated-to-common channel type switch is used as an illustration. “Switch down” means switching from a dedicated type of radio channel (or other higher capacity or quality channel) to a common type of radio channel (or other lower capacity or quality channel) typically because there is not enough data in the user connection to justify use of the dedicated channel (or other higher capacity or quality channel) for that user connection. “Switch-up” refers to switching in the opposite direction from common to dedicated channel. The amount of data stored in the transmit buffer is determined and ultimately used to verify that the “switch-up” condition(s) are not fulfilled (block 132). See also block 149 in FIG. 8 (block 132). Smaller amounts of data can typically be more efficiently transmitted, from a system perspective, on a common channel which multiplexes the data transmissions of several users at one time.

An optional expiration timer may also be used as an additional parameter before making a switch from a dedicated to a common channel. If the expiration timer times out, a switch to the common channel is permitted assuming any other imposed conditions are satisfied. Until the timeout occurs, however, switching to the common channel is not permitted. The timer length may be set, for example, based on system load, user priority, QoS, etc. (block 134). If the load is increasing, the timeout value may be decreased. Conversely, if the load is decreasing, the timeout value may be increased. A short timeout value is usually appropriate if radio resources are in high demand. Quality of service may also be accounted for in the timeout value. The presence of a high priority user, for example, would usually increase the timeout value before the switch is made to the less desirable common channel.

Block 136 describes throughout operations. The incoming data rate for the user connection, (i.e., at what speed is the user data coming into the transmission buffer), is determined. The current user throughput over the dedicated channel, (i.e., the speed at which the user data is leaving the transmission buffer), is determined. The current throughput on the common type of control channel is also determined. The common channel throughput for the user is estimated, for example, as a function of the maximum capacity of the common channel, the current number of connections using the common channel plus the user connection being considered for switching, and optional parameters like the priority of the user connection. Of course, other factors may be considered. Typically, the more users transmitting over the common channel, the lower the throughput. Retransmitted erroneous packets further lower the throughput.

A decision is made in block 138 whether the current user throughput on the dedicated channel is less than a throughput threshold T₁. If not, a channel type switch is not currently desired, the expiration timer is reset if previously started (block 140), and the user connection remains on the dedicated channel (block 142). However, if the current throughput on the dedicated channel is less than the throughput threshold T₁, a channel switch to the common channel is possible. A decision is made in block 144 whether the largest value of the current user throughput is greater than the common channel throughput estimated for that user connection. If not, the optional timer is reset (block 140), the user connection stays on the dedicated channel (block 142), and the process repeats at block 132.

If the largest value of the current user throughput is less than the common channel throughput estimated for that user connection, the expiration timer is started (assuming it has not already been started) (block 146). A decision is made in block 148 whether the timer has expired. If not, the user connection stays on the dedicated channel (block 142), and the process repeats at block 132. However, if the timer has expired, a decision is made in block 149 whether the channel-type switching condition(s) in the opposite direction (common channel-to-dedicated channel) are satisfied for this user connection. If so, the user connection is maintained on the dedicated channel to avoid being switched right back to the dedicated channel, and the process repeats at block 132. Otherwise, a decision is made whether any other optional imposed conditions have been met in block 150. If there is an optional condition and it has not been met, the user connection remains on the dedicated channel (block 142), and the process repeats. If the optional condition has been met, the user connection is switched from the dedicated channel to a common channel (block 152).

If the amount of data is small and the throughput is reasonably high on the common channel, the likelihood that the user connection can be adequately supported by the common channel is reasonably high. Moreover, if the switch-up conditions are not satisfied, the likelihood of switching immediately back to a dedicated channel because too much data is accumulating for the mobile user connection over the common channel is low. In this way, undesirable channel-type switching is reduced or avoided.

The example channel-type switching procedures outlined in FIG. 8 base the channel-type switching decision on the current throughput over the common channel as well as on other factors. The channel switching decision may be decided based on a throughput comparison alone. Alternatively, that decision may be made based on (1) a comparison of the current throughput over the dedicated channel to a throughput threshold and (2) an expiration time where the expiration time is based on system load. If the current throughput on the dedicated channel is less than the throughput threshold and remains below that throughput threshold or some other offset threshold (e.g., a somewhat higher threshold) for a time out period, the user connection may be switched to the common channel. This non-limiting alternative does not consider the throughput on the common channel—only that on the dedicated channel. Unnecessary channel switching is reduced using an expiration timer to ensure a switch is warranted. In this embodiment, a longer timeout value may be justified. However, additional consideration of the throughput on the common channel and the switch-up criteria provides greater protection against an unwise channel switch, e.g., the common channel is very heavily loaded and therefore may have too low of a throughput even for a user connection with only a modest throughput requirement.

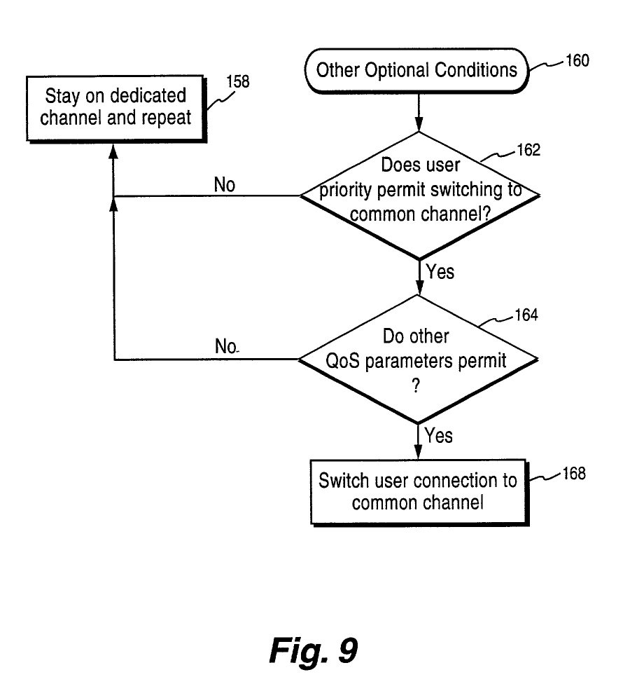

Other additional conditions may be considered in the channel switching decision before switching from a dedicated channel to the common channel. Some example optional factors referred to in block 150 in FIG. 8 are now described in conjunction with the “Other Conditions” flowchart (block 160) shown in FIG. 9. A priority condition is tested to determine whether the user connection priority permits switching to a common channel (block 162). For example, certain high priority user connections typically will not be switched to the common channel. In this case, the high priority user connection is maintained on the dedicated channel (block 158). Decision block 164 determines whether other Quality of Service (QoS) parameters associated with the user connection permit switching to a common channel. For example, the quality of service may require a guaranteed small delay which may be important for the user connection. In that situation, the connection is maintained on the dedicated channel (block 158). If all other optional conditions are satisfied, the user connection is switched to the common channel.

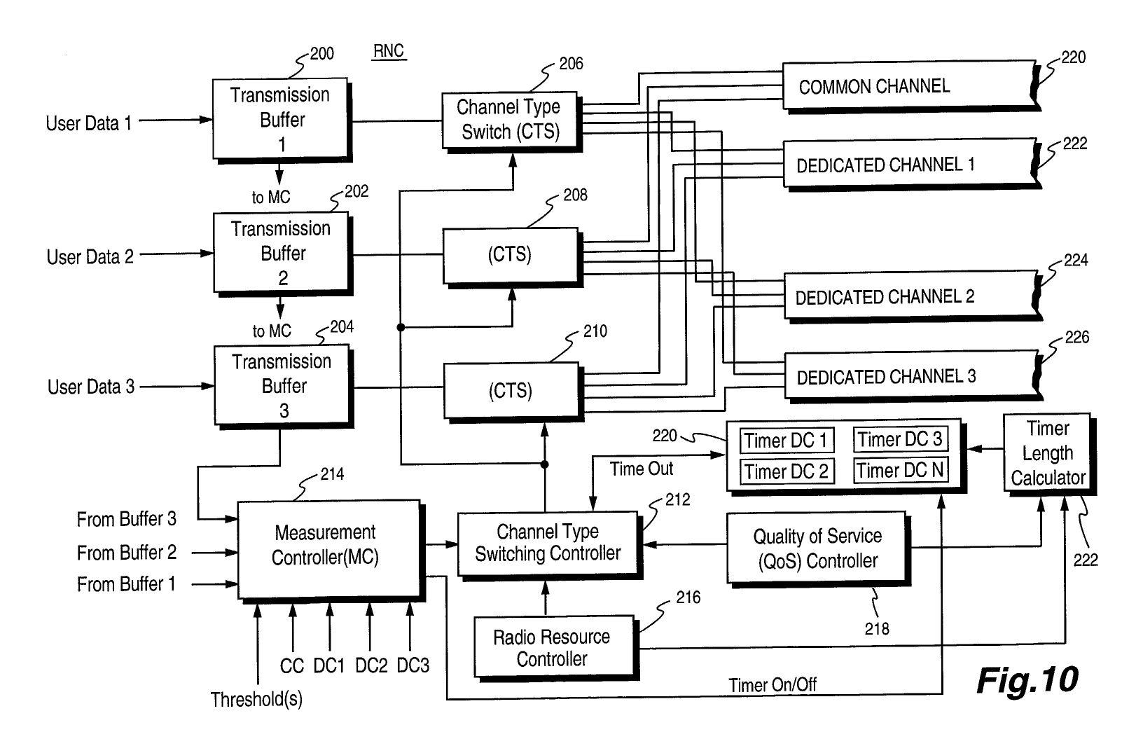

FIG. 10 illustrates an example implementation of the present invention as implemented in a radio network controller (RNC). In this example, three user data connections 1, 2, and 3 are coupled to respective transmission buffers 1-3 (200-204), e.g., RLC buffers. The amount of data currently stored in each of the three transmission buffers is provided to the measurement controller (MC) 214. Measurement controller 214 also receives measurements from which the current throughput rate on the common channel 220 is estimated and the current incoming and outgoing data rates for each user connection on a dedicated channel are determined. Each transmission buffer 200-204 is coupled to a corresponding channel-type switch (CTS) 206, 208, and 210 that may be implemented for example at the MAC layer. Each of the channel-type switches is controlled by a channel-type switching controller 212 which receives measurement inputs from measurement controller 214, and if desired, additional optional inputs from timers 220, radio resource controller 216, and/or quality of service controller 218. Each dedicated channel is associated with an expiration timer, e.g., timer DC1-timer DCN. A timer length calculator 222 determines the expiration length for each timer based for example on available radio resources from radio resource controller 216 and/or quality of service requirements for the user connection received from QoS controller 218.

The measurement controller 214 makes throughput comparisons, transmit buffer comparisons, and activates or deactivates a corresponding expiration timer 220 depending on the throughput or buffer comparisons (see the timer ON/OFF signal). Based on the inputs from measurement controller 214, radio resource controller 216, QoS controller 218, the channel-type switching controller 212 appropriately routes data from each of the transmission buffers via its respective channel-type switch (206-210) to the selected type of traffic channel. Of course, a channel type switch is not made if it is unwise or if it is not necessary.

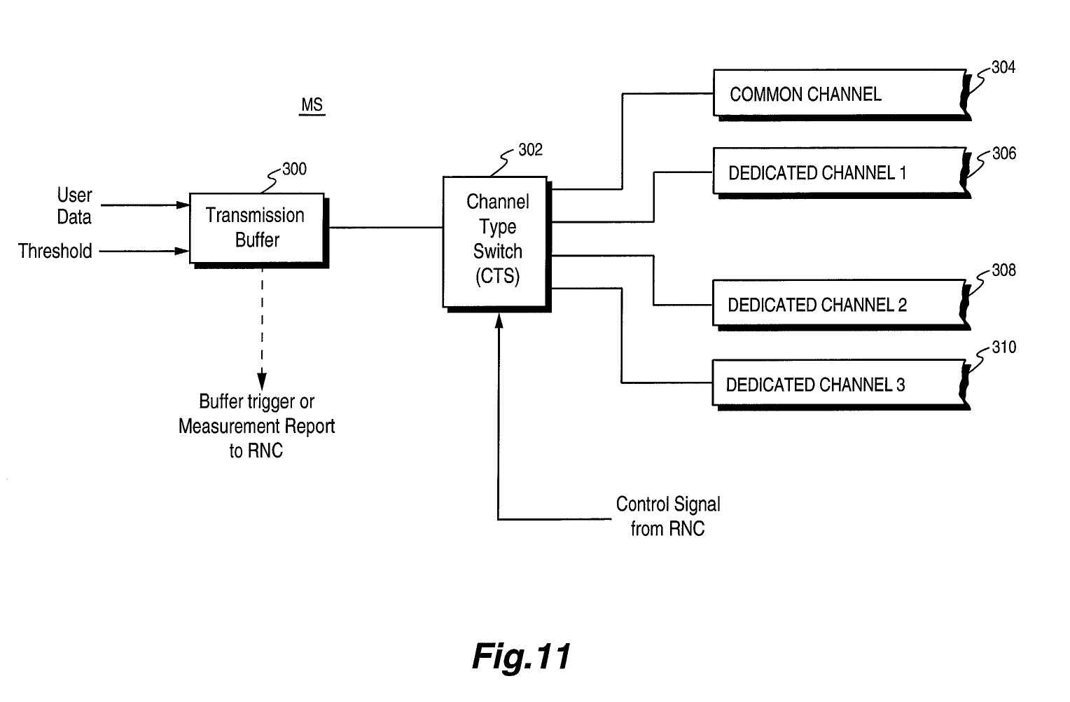

In this example, many of the functions of the invention are performed in the RNC (or some other radio network node). Accordingly, the mobile station need only support the RNC with information and follow instructions. Referring to FIG. 11, uplink user data is received and stored at a transmission buffer 200, e.g., an RLC buffer. Packets output from the transmission buffer 300 are routed to a channel-type switch (CTS) 302 (e.g., implemented at the MAC layer) to an appropriate communications channel including one or more common channels 304 or dedicated channels DC1-DC3 (306-310). The channel-type switch is controlled by a signal from the RNC. The buffer 300 may optionally send a trigger signal to the RNC when the amount of data to be sent exceeds a threshold. Alternatively, measurement reports could be sent specifying incoming and outgoing data rates, the actual data amount buffered, etc. Other implementations may involve the mobile more substantially.

The present invention provides a number of advantages. The invention prevents making channel-type switches that are unnecessary or inefficient. The chances of rapid cyclic switching (“ping-ponging”) are considerably reduced or eliminated. The invention dynamically adapts to different system conditions, and also flexibly supports different user priorities so that higher users can achieve a higher throughput without adversely impacting the efficient use of limited resources for lower priority users. Data processing, channel, and other resources associated with channel switching are also used in a more efficient fashion.

While the present invention has been described in terms of a particular embodiment, those skilled in the art will recognize that the present invention is not limited to the specific example embodiments described and illustrated herein. Different formats, embodiments, and adaptations besides those shown and described as well as many modifications, variations, and equivalent arrangements may also be used to implement the invention. Accordingly, it is intended that the invention be limited only by the scope of the claims appended hereto.

What is claimed is:

1. In a mobile radio communications system having two different types of communications channels including a first type of channel and a second type of channel, a method comprising:
providing the first type of channel to support a user connection;
estimating a throughput on the second type of channel; and
determining whether to switch the user connection from the first type of channel to the second type of channel based on the estimated throughput on the second type of channel.

2. The method in claim 1, further comprising:
starting a timer when a throughput on the first channel is less than a first threshold;
wherein the user connection is switched to the second channel only when the throughput on the first channel remains below the first threshold for a predetermined time period.

3. The method in claim 2, wherein the time period is a function of a load in the mobile radio communications system.

4. The method in claim 2, wherein the time period is a function of an availability of radio resources.

5. The method in claim 2, wherein the time period is a function of a quality of service associated with the user connection.

6. The method in claim 2, wherein the user connection is switched to the second channel of the throughput on the first channel remains below the first threshold for a predetermined time period and the detected throughput on the second channel is greater than a second threshold.

7. The method in claim 1, further comprising:
switching the user connection to the second type of channel when the detected throughput is greater than a throughput threshold.

8. The method in claim 1, further comprising:
detecting the throughput on the first channel;
comparing the throughputs on the first and second channels; and
switching the user connection if the throughput on the second channel exceeds the throughput on the first channel.

9. The method in claim 1, wherein the first type of channel is a dedicated radio channel allocated to support a single user connection and the second type of channel is a common radio channel allocated to support plural user connections.

10. The method in claim 1, wherein the first type of channel is a first common channel and the second type of channel is a second common channel.

11. The method in claim 1, wherein the first type of channel is a higher capacity or quality channel than the second type of channel.

12. The method in claim 1, wherein the user connection is switched from the first channel to the second channel when the detected amount of data to be transmitted is less than an amount threshold associated with switching from the second channel to the first channel.

13. The method in claim 12, wherein the determination whether to switch the user connection from the first channel to the second channel is also based on whether the estimated throughput on the second channel exceeds a current data rate on the first channel.

14. The method in claim 1, further comprising:
detecting one or more other parameters,
wherein the determination is also made based on the detected one or more other parameters.

15. The method in claim 14, wherein the one or more parameters includes a timeout condition.

16. The method in claim 14, wherein the one or more parameters includes a throughput on the first channel.

17. The method in claim 14, wherein the one or more parameters includes a priority associated with the user connection.

18. The method in claim 14, wherein the one or more parameters includes a quality of service associated with the user connection.

19. The method in claim 14, wherein the one or more parameters includes a current amount of data to be transmit over the first channel.

20. The method in claim 1, wherein the determination decreases undesirable channel-type switching of the user connection between the first and second channel-types.

21. In a mobile radio communications system having two different types of communications channels including a first type of channel and a second type of channel, a method comprising:
providing the first type of channel to support a user connection;
detecting a parameter affecting a decision whether to switch the user connection from the first type of channel to a second type of channel; and
controlling the channel switching decision so as to reduce undesirable channel-type switching.

22. The method in claim 21, wherein the controlling step prevents unnecessary, excessive, or rapid cyclic switching of the user connection between the first and second channel-types.

23. The method in claim 21, wherein the controlling step prevents making a channel-type switch when a cost of making the channel-type switch to the second type of channel is more expensive than a cost of maintaining the user connection on the first type of channel.

24. The method in claim 21, wherein the controlling step includes taking into account a throughput over the second type of channel.

25. The method in claim 24, wherein the controlling step includes taking into account a user connection date rate on the first channel.

26. The method in claim 25, wherein the controlling step includes taking into account a time period for which the user connection data rate on the first channel exceeds a threshold.

27. The method in claim 21, wherein the controlling step includes taking into account one or more other parameters including a quality of service associated with the user connection.

28. In a mobile communications system including plural base stations coupled to a controller and communicating over a radio interface with mobile stations, a control node comprising:
plural buffers, each buffer assignable to support a mobile user connection and having a first threshold;
channel-type switching circuitry, coupled to the buffers, controllably switching a user connection from a first type of radio channel to a second type of radio channel;
a measurement controller obtaining measurements of a current throughput on the second type of radio channel; and
a channel-type switching controller controlling the channel-type switching circuitry to direct the data corresponding to one of the mobile user connections stored in one of the buffers from a first type of radio channel currently supporting the mobile user connection to a second type of radio channel based on the measurements from the measurement controller.

29. The control node in claim 28, wherein the control node corresponds to a radio network controller coupled to plural base stations.

30. The control node in claim 28, wherein the first type of radio channel is one of a dedicated radio channel reserved for one mobile user and a common radio channel shared by plural mobile users and the second type of radio channel is the other of the dedicated radio channel and the common radio channel.

31. The control node in claim 28, wherein the channel switching controller makes the channel-type switch when the throughput on the second channel is greater than or equal to a data rate required for the user connection.

32. The control node in claim 28, wherein the channel-type switch is made when the throughput on the second channel exceeds a threshold for a predetermined time period.

33. The control node in claim 28, further comprising:
a radio resource controller coupled to the channel-type switching controller,
wherein the channel-type switching controller controls the channel-type switching taking into account an availability of radio resources provided by the radio resource controller.

34. The control node in claim 28, further comprising:
a quality of service controller providing quality of service parameter information to the channel-type switching controller,
wherein the channel-type switching controller controls the channel-type switching taking into account a quality of service parameter associated with the mobile user connection.

35. In a mobile radio communications system having two different types of communications channels including a first type of channel and a second type of channel, an apparatus comprising:
means for providing the first type of channel to support a user connection;
means for detecting a parameter affecting a decision whether to switch the user connection from the first type of channel to a second type of channel; and
means for controlling the channel switching decision so as to reduce undesirable channel-type switching.

36. The apparatus in claim 35, wherein the means for controlling prevents unnecessary, excessive, or rapid cyclic switching between the first and second channel-types supporting the user connection.

37. The apparatus in claim 35, wherein the means for controlling prevents making a channel-type switch when a cost of making the channel-type switch to the second type of channel is more expensive than a cost of maintaining the user connection on the first type of channel.

38. The apparatus in claim 35, wherein the means for controlling includes taking into account a throughput over the second type of channel and one or more conditions established for switching the user connection from the second channel to the first channel.

39. In a mobile communications system, a method comprising:
providing a first type of channel to support a user connection;
detecting a throughput on the first channel;
comparing the detected throughput to a first threshold;
monitoring the time when the detected throughput is less than the first threshold; and
switching the user connection to a second type of channel if the monitored time exceeds a predetermined value.

40. The method in claim 39, wherein the predetermined value is based on a load in the mobile radio communication system.

41. The method in claim 39, wherein the predetermined value is based on an availability of channel resources.

42. The method in claim 39, wherein the predetermined value is based on a quality of service associated with the user connection.

43. The method in claim 39, wherein the switching is performed when the monitored time exceeds the predetermined value and a throughput on the second channel exceeds the throughput on the first channel.
